(19) United States
(12) Patent Application Publication
(10) Pub. No.: US 2003/0228465 A1
(43) Pub. Date: Dec. 11, 2003

(54) Unconsolidated surface material and method of making same

(76) Inventor: Gerald P. Coffey, Chagrin Falls, OH (US)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 10/386,387

(22) Filed: Mar. 10, 2003

Related U.S. Application Data
(63) Continuation-in-part of application No. 10/027,718, filed on Dec. 20, 2001.
(60) Provisional application No. 60/257,231, filed on Dec. 21, 2000.

(51) Int. Cl. B32B 5/16

(52) U.S. Cl. 428/407; 428/403

(57) ABSTRACT

The present invention is directed to unconsolidated surface material comprising rubber particles, a color coating covering the rubber particles; and a polymer coating covering the color coating. The unconsolidated surface material is made by mixing rubber particles with a colorant to color coat the rubber particles thereby forming colored rubber particles and adding an emulsion polymer to the colored rubber particles to coat the colored rubber particles with the emulsion polymer to form a protective film around the colored rubber particles. The unconsolidated surface material may be used as synthetic mulch or as a playground safety surface.

### CROSS-REFERENCE WITH RELATED APPLICATIONS

This application is a continuation-in-part of U.S. application Ser. No. 10/027,718 filed on Dec. 20, 2001 which claims priority to U.S. Provisional Patent Application No. 60/257,231 filed on Dec. 21, 2000.

### BACKGROUND OF THE INVENTION

Ongoing efforts have been made to improve the quality of the environment by removing scrap tires from landfills and converting them to useful products. Legislative initiatives have addressed the removal of scrap tires from the environment and the conversion of scrap tires into useful products. A common theme in scrap tire conversion is grinding the tires to produce various sized and shaped rubber particles which can then be put to a productive use. Typical uses of scrap tire grinds include supplemental feedstocks to enhance the BTU fuel value of selected energy sources, backfill materials to facilitate drainage around foundations, additives to enhance the surface characteristics of various materials used in road construction, soil amendments to provide solutions to soil compaction, building products such as aerosol based roofing and weatherproofing systems, and recreational safety surfaces.

Scrap tire grinds are also commonly used for products such as landscaping mulch and protective surfaces for playgrounds. In fact, the Consumer Product Safety Commission has given its highest rating to rubber particles as the preferred choice of material to be used on playground surfaces to protect children from falls. The protection offered by rubber particles against falls has been proven to be far superior to any other material commonly used for this purpose in playgrounds, including wood chips, bark mulch, sand, and pea gravel.

Coloring of vulcanized rubber particles and especially the attendant color durability are technically challenging issues. Thus, vulcanized rubber products for landscaping mulch and protective safety surfaces for playgrounds have generally been limited to uncolored scrap tire grinds. However, efforts have been made to address the demand for colored surfaces. For example, the use of water soluble colorants compounded with a modified acrylic copolymer and rheological additives as well as the formation of artificial mulch chips from thermoplastic materials have been described as efforts to address this demand.

U.S. Pat. No. 5,105,577, U.S. Pat. No. 5,396,751, U.S. Pat. No. 5,543,172, U.S. Pat. No. 5,910,514, and U.S. Pat. No. 6,036,998 describe various processes and products relating to colorized rubber, mulch chips and the like.

Methods known in the art for coloring vulcanized rubber particles are notably inadequate to satisfy requirements for applications such as playground safety surfaces and landscape mulch. In many cases, an important factor responsible for marginal to poor performance characteristics relating to color durability and color abrasion resistance is the use of a one step process to color and seal the colorant onto the rubber particles. In the one step process, a mixture containing both the colorant and the polymer (used to seal the colorant onto the vulcanized rubber particles) is added to the vulcanized rubber particles and, consequently, both the colorant and the polymer are present at the same time. Accordingly, when added to raw vulcanized rubber particles, there is a competition between the colorant and the polymer for the surface of the rubber particle. Every time the polymer binds itself to the surface of the raw rubber particle first (i.e., before the colorant binds to that same location on the surface of the raw rubber particle), its concentration is effectively reduced to form a protective polymer coating that binds the colorant onto the rubber surface. This leads to unsatisfactory performance especially with respect to color abrasion resistance since the thickness of the protective polymer coating is diminished due to the polymer commingling with the colorant. Additionally, some vulcanized rubber coloring systems contain volatile organic compounds (VOCs) that can participate in atmospheric photochemical reactions and can therefore be unfriendly and polluting to the environment.

It therefore can be appreciated that the utility of scrap vulcanized tire grinds for large scale manufacture of unconsolidated, loose fill products such as landscaping mulch and playground protective surfaces would be greatly enhanced by using a low cost, safe, and nontoxic coloring process that provides uniform coloration as well as color durability and permanence. Since utilization of scrap tire particles is based on both performance and appearance, efficient coloring of scrap tire grinds would enhance aesthetic value considerably. Consequently, there is a need for an effective method of coloring vulcanized rubber particles that provides a more durable and more uniform color coating on such materials.

### SUMMARY OF THE INVENTION

One embodiment of the present invention is unconsolidated surface material comprising rubber particles, a color coating covering the rubber particles, and a polymer coating covering the color coating. The unconsolidated surface material may be used as a playground safety surface or as landscaping mulch.

The color coating may comprise an organic pigment or an inorganic pigment. The color coating may also further comprise an opacifying pigment, an extender, a nonionic and/or an anionic surfactant, and a rheology control agent.

The polymer coating is an emulsion polymer that may be selected from a group of linear polymers comprising a styrenic copolymer, an acrylic copolymer, a vinyl acetate/acrylic copolymer or a vinyl acetate homopolymer. The styrenic copolymer, the acrylic copolymer or the vinyl acetate/acrylic copolymer optionally may be self-crosslinking. Alternatively, the styrenic copolymer, the acrylic copolymer, the vinyl acetate/acrylic copolymer or the vinyl acetate homopolymer may be subsequently crosslinked by addition of various polymers or low molecular weight materials especially those containing nitrogen. The nitrogen containing polymer may be an aliphatic polyurethane, a polyamine, a polyamide, a polyimide or polymers with nitrogen containing end groups. Low molecular weight materials may contain reactive nitrogen moieties such as ethylenediamine, tetramethylenediamine, hexamethylene-diamine, 2-methylpentamethylenediamine, 1,3-pentanediamine, 1,2-diaminocyclohexane, and bis-(hexamethylene)triamine. The styrenic copolymer may be a linear or crosslinked styrene/acrylic copolymer. The crosslinking reaction can be accelerated by application of heat and/or catalyst addition. Use of a catalyst also may increase the crosslinking density.

Another embodiment of the present invention is a method of preparing unconsolidated surface material comprising the steps of: mixing rubber particles with a colorant to color coat the rubber particles thereby forming color coated rubber particles; and adding an emulsion polymer to the color coated rubber particles to coat the colored rubber particles with the emulsion polymer to form a protective film around the colored rubber particles. The method may further comprise the step of drying the colored rubber particles coated with the emulsion polymer to form a protective film around the colored rubber particles.

Another embodiment of the present invention provides a method of preparing a synthetic mulch comprising the steps of: mixing rubber particles with a colorant to color coat the rubber particles thereby forming colored rubber particles and mixing the colored rubber particles with an emulsion polymer to seal the colored rubber particles.

Another embodiment of the present invention provides a method of converting vulcanized rubber particles into loose-fill surface covering material comprising: mixing vulcanized rubber particles with an aqueous pigment dispersion to color coat the vulcanized rubber particles and adding a polymer to the color coated rubber particles to encapsulate the color coated rubber particles and form a protective film around the color coated rubber particles.

### BRIEF DESCRIPTION OF THE DRAWINGS

These and other features, aspects, and advantages of the present invention will become better understood with regard to the following description, appended claims, and accompanying drawings where:

FIG. 1 is a simplified elevational view of apparatus 10 for manufacturing unconsolidated surface material according to one embodiment of the present invention; and

FIG. 2 is a detailed perspective view of hopper 20 and vibrating conveyor 55 which are components of apparatus 10.

### DETAILED DESCRIPTION OF THE INVENTION

According to one embodiment of the present invention, unconsolidated (or loose-fill) surface material comprises rubber particles, a color coating (or layer) covering the rubber particles, and a polymer coating (or layer) covering the color coating (or layer) to seal and protect the color coating. Unconsolidated surface material may be used in a variety of applications, for example, as a playground safety material or as a landscaping mulch.

According to another embodiment of the present invention, a method of preparing unconsolidated surface material comprises the steps of: (i) mixing rubber particles with a colorant to form colored rubber particles, and (ii) in a second and distinct step, mixing the colored rubber particles with an emulsion polymer to encapsulate and form a protective film around the colored rubber particles thereby forming colored and sealed rubber particles. This method may also be referred to as a “two step” method or process because the coloring step is separate from the sealing step, but in no way does this term insinuate that the method of preparing unconsolidated surface material only includes two steps since it may include other steps. For example, although binding of the colorant and polymer to the rubber particle may occur via air drying, the binding interactions may be generally enhanced or may take place faster by the application of heat. Accordingly, the method described above may further include the step of drying the colored and sealed rubber particles following step (ii).

“Rubber particles”, “rubber fragments”, “rubber slivers”, “rubber chunks”, “rubber buffings”, and “rubber nuggets” may be used interchangeably herein and include natural and synthetic rubber materials. Suitable synthetic rubber materials include, for example, polyisoprene, polychloroprene, polybutadiene, ethylene-propylene copolymers, butadiene/styrene copolymers, acrylonitrile/butadiene copolymers, and ethylene/vinyl acetate copolymers.

Vulcanized rubber particles may be produced from shredding, milling, and buffing used vulcanized rubber tires and are available in various sizes and shapes depending on the application. Two typical types of vulcanized rubber tire grinds known in the industry are nuggets and buffings.

Vulcanized rubber nuggets are irregular shaped pieces of vulcanized rubber. They may contain various proportions of free and bound fiber depending on the type of precursor tire used. Thus, vulcanized rubber nuggets sourced from automobile passenger tires contain noticeable free and bound fiber, while those sourced from truck tires contain very low levels of free and bound fiber. Also, vulcanized rubber nuggets may be blends derived from both automobile and truck tires. One example of a commonly used tire grind utilized in the present invention is referred to in the industry as a ¾ minus grind vulcanized rubber nugget. The major dimension of these irregularly shaped ¾ minus grind vulcanized rubber nuggets is between about 0.125 to about 1.0 inch with the predominant nugget size in the 0.5-0.75 inch range. Vulcanized rubber nuggets are generally used in playground safety surface applications.

Vulcanized rubber buffings are thin, elongated slivers of vulcanized rubber that have a bark-like texture. They are normally derived from the treads of truck tires. Designated as +4 or +5 buffings, dimensions range from about 0.5 to about 4.0 inches long, by about 0.125 to about 1.50 inches wide, by about 0.10 to about 0.50 inch thick. Dimensions of buffings typically used in this invention are about 1.25 to about 2.0 inches long, by about 0.375 to about 0.75 inch wide, by about 0.05 to about 0.2 inches thick.

Vulcanized rubber buffings may be used in admixture with vulcanized rubber nuggets in various proportions depending on the application. For example, a 70/30 blend of nuggets and buffings means there are 70% nuggets and 30% buffings in the mixture. When added to nuggets, buffings help consolidate the loose fill bed and tend to enhance the cushioning and feel when used in playground safety surface applications. For landscaping mulch applications, buffings added to nuggets change the appearance of an area to more closely resemble the look of natural wood mulch since the buffings have a bark-like texture. It is to be understood; however, that other sizes of vulcanized rubber nuggets and buffings may be used in both playground safety surface and landscaping mulch applications.

Sulfur vulcanization is the most common approach for producing rubber compounds with properties suitable for tire applications. The operative mechanism for sulfur vulcanization was originally thought to be free radical, but later work points to an ionic mechanism. Regardless of the operative mechanism, key structural moieties in vulcanized rubber can be represented as

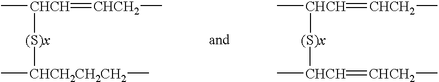

where x is a small number. There may also be a few residual unsaturation sites from parts of elastomer backbones not involved in the vulcanization reaction.

While not wishing to be bound by theory, coloring rubber can be achieved as a consequence of electronic interactions between the pigment, and the residual unsaturation and sulfur linkages in vulcanized rubber. However, the nature of these electronic interactions is weak. Because only unshared electron pairs on the sulfur atoms and/or pi-bond orbital overlap of the residual unsaturation are involved with the polar sites of the pigment, there are no direct covalent bonds formed between the pigment and the available sites on the vulcanized rubber. Because of these weak electronic interactions, it is generally observed that adhesion of pigment to vulcanized rubber particles is marginal to poor. This leads to unsatisfactory performance of colored vulcanized rubber particles, particularly with regard to properties such as color abrasion resistance and color permanence when exposed to aqueous environments in applications such as protective surfaces for playgrounds and landscaping mulch.

To optimize the brilliancy of pigments coating bare vulcanized rubber particles, the colorants utilized to color rubber particles are preferably aqueous pigment dispersions formulated using very high shear conditions. Both organic and inorganic pigments may be used to form the aqueous pigment dispersions. Organic pigments offer a wide range of brilliant colors and are much more expensive than inorganic pigments. For reasons of economy, organic pigments are generally used at much lower concentrations than inorganic pigments. Typically, organic pigments are conjugated structures, optionally complexed with metal atoms. Copper phthalocyanine is a very well known organic pigment and is useful for providing a brilliant blue coloration to vulcanized rubber particles of the present invention. The structure of copper phthalocyanine is depicted below:

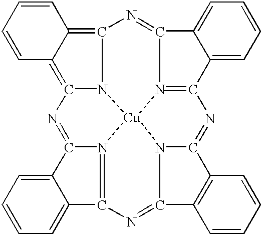

This complexed conjugated structure may exhibit electronic interactions with the vulcanized rubber structure shown above through pi-bond orbital overlap of the C═N unsaturated moieties with the residual unsaturation. Weak interactions between the aromatic nuclei of the copper phthalocyanine and the residual unsaturation of the vulcanized rubber, as well as interactions of the copper atom with the sulfur bonds, are also possible. Steric interactions are minimized due to the planarity of the copper phthalocyanine molecule thereby enabling requisite proximate approach of the pigment molecule to the locus of the crosslinked vulcanized rubber structure.

Like other organic pigments, copper phthalocyanine exists in various crystalline modifications. Copper phthalocyanine with color index name C.I. Pigment Blue 15:3 and C.I. Pigment Blue 15 are preferred for use in the present invention.

In addition to copper phthalocyanine to produce blue vulcanized rubber particles, other organic pigments may be employed in the present invention to produce colored rubber particles other than blue. For example, chlorinated copper phthalocyanine (color index name C.I. Pigment Green 7) can be used to produce a medium green color. Violet can be derived from the dioxazine family, from a material known as 8,18-dichloro-5,15-diethyl-5,15-dihydrodiindolo [3,2-b:3′,2′-m] phenodioxazine (C.I. Pigment Violet 23). Organic pigment dispersions may be used singly or blended together to produce many different colors and shades of color.

Aqueous dispersions of organic pigments may be prepared in the presence of opacifying pigments such as titanium dioxide. Rutile grades of titanium dioxide have less tendency to chalk and are preferred over anatase grades. The aqueous dispersion may also contain other pigments such as zinc oxide and silicon dioxide, as well as extenders such as calcium carbonate.

Another aspect of the present invention is the identification of efficient surfactants to promote the formation of high quality, relatively stable aqueous pigment dispersions. A high quality aqueous dispersion is essential to ensure uniform delivery of pigment molecules to the vulcanized rubber sites. An aqueous pigment dispersion capable of preventing premature settling and agglomeration of pigment and additives is desired. Surfactants especially suitable for the purpose of promoting high quality and stable aqueous dispersions for organic pigments are those selected from groups based on alkyloxypolyethyleneoxyethanols (secondary alcohol ethoxylates) and octylphenoxypolyethoxyethanols (alkylphenol hydroxypolyoxyethylenes). Examples of the first category of nonionic surfactants are Tergitol 15-S-7 and Tergitol 15-S-9. These surfactants are available commercially from Union Carbide Corporation (Danbury, Conn.). The structure of Tergitol surfactants can be represented as follows:

C₁₂₋₁₄H₂₅₋₂₉0(CH₂CH₂0)ₓH

where x=3-40.

Examples of the second category of nonionic surfactants are known as Triton X-45 and Triton X-100. These materials also are available commercially from Union Carbide Corporation. The structure of Triton surfactants is represented as follows:

C₈H₁₇C₆H₄0(CH₂CH₂0)ₓH

where x=1-55.

The above classes of nonionic surfactants can be used to prepare aqueous pigment dispersions for a variety of organic pigments. They can be used singly or in admixture with each other or in admixture with other nonionic and/or anionic surfactants. Low levels of other ingredients such as Theological control agents, for example, may be required in admixture with the nonionic and/or anionic surfactants. Suitable rheological agents are hydroxy ethyl cellulose, ethyl hydroxyl ethyl cellulose, carboxymethyl cellulose, and bentonite clays. Other materials such as lecithin and polyvinyl pyrrolidone may also be incorporated with the nonionic surfactants.

The addition of small amounts of these types of stable aqueous dispersions of organic pigment to vulcanized rubber granules followed by efficient mixing results in uniform color coverage of the rubber particles. The brightness of the color depends on the amount of titanium dioxide pigment and the amount of calcium carbonate extender used. Generally a brighter and lighter coloration is obtained with higher titanium dioxide concentrations. Many aesthetically pleasing shades of coloration on rubber particles can be obtained using various ratios of titanium dioxide and calcium carbonate.

The total solids content of stable aqueous organic pigment dispersions of the present invention is in the range of about 30% to about 70%. Preferably, the total solids is in the range of about 32% to about 65%. The concentration range for copper phthalocyanine is about 0.9 to about 22.5 weight percent. The preferred concentration range for copper phthalocyanine is about 1.5 to about 14.5 weight percent. The concentration of titanium dioxide (and optionally other pigments and extenders) ranges from about 85 to about 99 weight percent of the total solids content, and the preferred concentration range is about 77.5 to about 99.10 weight percent of the total solids content.

Aqueous organic pigment dispersions may be added to the rubber particles in concentrations ranging from about 0.01 to about 8.00 weight percent with respect to the total weight of the rubber particles. A more preferred range of aqueous organic pigment dispersion to be used with the rubber particles is about 0.05 to about 6.00 weight percent with respect to the total weight of the rubber particles. A most preferred range of aqueous organic pigment dispersion to be used with the rubber particles is about 0.5 to about 1.3 weight percent with respect to the total weight of rubber depending on the color and type of rubber particles (e.g, vulcanized rubber nuggets, vulcanized rubber buffings, or combinations thereof).

Alternatively, inorganic pigments may be utilized to achieve more earth tone types of colors popular for landscaping mulch applications as well as for some playground safety surface applications. These inorganic pigments are based mainly on synthetic iron oxides and are typically available in red, brown, and yellow colors. There are other colors available based on different inorganic oxides.

Rohm and Haas Company (Philadelphia, Pa.) offers a line of Tamol dispersants that can be used in forming stable aqueous dispersions of various inorganic pigments. One of these dispersants is referred to as Tamol 1124 (also called Orotan 1124) and is available as an approximate 50% solution in water. Other variants of anionic polyacrylic acid and esters can be used to disperse inorganic pigments. Anionic surfactants such as sodium dioctylsulfosuccinate, ammonium lauryl sulfate, sodium lauryl sulfate, and sodium dodecylbenzenesulfonate may be used to disperse inorganic pigments. Nonionic surfactants such as the Tergitol and Triton series described above may be used in admixture with Tamol 1124 and other surfactants described herein to form stable aqueous dispersions of inorganic pigments. The effectiveness of these materials and other anionic surfactants may be improved by incorporation of rheology control agents such as hydroxyethyl cellulose, ethyl hydroxyethyl cellulose, carboxymethyl cellulose, and bentonite clays. Other materials such as lecithin and polyvinyl pyrrolidone may be incorporated with these surfactants. Aqueous inorganic dispersions may also contain other pigments such as titanium dioxide, zinc oxide and/or silicon dioxide as well as extenders such as calcium carbonate.

Addition of low levels of these types of stable aqueous dispersions of inorganic pigments to vulcanized rubber particles provides uniform coloring. Optional use of titanium dioxide with certain inorganic pigments lightens the coloration slightly. Addition of titanium dioxide pigment is preferred with lighter inorganic pigment dispersions to attenuate the inherent black coloration of the vulcanized rubber particles. In some cases, calcium carbonate extender may be used to lower overall colorant costs.

The total solids content of stable aqueous inorganic pigment dispersions of the present invention is in the range of about 25% to about 65%. Preferably, the total solids is in the range of about 28% to about 62%. Of the solids content in a stable aqueous dispersion of iron oxide, the concentration of iron oxide is in the range of about 50 to about 100 weight percent. The preferred concentration range for iron oxide is about 55 to about 95 weight percent. The concentration of titanium dioxide (or optionally other pigments and/or extenders), when used, ranges from about 27 to about 40 weight percent. However, it is understood that inorganic oxide pigment also may be used alone as the active colorant in aqueous inorganic pigment dispersions without the use of titanium dioxide and/or extenders.

Aqueous inorganic pigment dispersions may be added to the rubber particles in concentrations ranging from about 0.01 to about 8.00 weight percent with respect to the total weight of the rubber particles. A more preferred range of aqueous inorganic pigment dispersion to be used with the rubber particles is about 0.05 to about 6.00 weight percent with respect to the total weight of the rubber particles. A most preferred range of aqueous inorganic pigment dispersion to be used with the rubber particles is about 0.5 to about 1.3 weight percent with respect to the total weight of rubber depending on the color and type of rubber particles (e.g, vulcanized rubber nuggets, vulcanized rubber buffings, or combinations thereof).

Although the colorants described above are aqueous based pigment dispersions, one skilled in the art would recognize that non-aqueous based colorants may be used and still be within the scope of the present invention.

The emulsion polymer, added to the colored rubber particles in a second distinct step, encapsulates and seals the colored rubber particles and forms a protective film around the colored rubber particles providing improved abrasion resistance and color permanence especially when exposed to aqueous environments. The emulsion polymer may be selected from the group consisting of a styrenic copolymer, an acrylic copolymer, a vinyl acetate/acrylic copolymer or a vinyl acetate homopolymer. These copolymers or homopolymers may be linear, self-crosslinking, or subsequently crosslinked. Examples of emulsion polymers suitable for use in the present invention are Rhoplex P-308 and Rhoplex P-376 available from Rohm and Haas Company (Philadelphia, Pa.). Rhoplex P-308 and Rhoplex P-376 are styrene acrylic copolymers that are believed to be linear, but which optionally may contain moieties (e.g., carboxylic acid groups) that can promote formation of three dimensional polymer networks either by self-crosslinking or crosslinkable reactions, especially with the application of heat and/or a catalyst. Another example of an emulsion polymer suitable for use in the present invention is BondTite available from Barr Formulated Products (Wexford, Pa.) in at least three formulations BondTite 1000 Plus, BondTite 2000 Plus, and BondTite 3000 Plus. BondTite is believed to be an emulsion containing a crosslinked polyurethane-modified styrene acrylic copolymer.

As stated above, the emulsion polymer may be a linear structure that is designed to impart excellent color durability and adhesion resistance as a protective polymer coating. With linear polymers, the corresponding structures are tailored to provide protective polymer coatings that bind pigments to vulcanized rubber particles in a manner that assures outstanding color durability and abrasion resistance performance.

Alternatively, the polymer coating may become increasingly protective by crosslinking reactions that form three dimensional network structures. In some cases, the emulsion polymer contains crosslinked structures already formed when it is added in the second distinct step. In this scenario, the crosslinked structures have been formed previously by crosslinkable reactions between a common functional group on chains in the emulsion polymer with added reactive moieties such as various nitrogen compounds or nitrogen containing polymers. These crosslinkable reactions normally are accelerated by the addition of heat and/or a catalyst.

In another embodiment, the emulsion polymer may be chemically modified to contain various functional groups that serve as a starting point to create protective encapsulating three dimensional networks. These emulsion polymers produce three dimensional networks by subsequent self-crosslinking reactions of functional groups attached to intermolecular chains. These self-crosslinking reactions are also accelerated by the addition of heat and/or a catalyst. Thus, in this case, the crosslinked three dimensional networks are produced by self-crosslinking reactions after the emulsion polymer is added to the colored vulcanized rubber particle in the second distinct step. Application of heat (as in drying) would increase the crosslink density in this case.

In yet another embodiment, the emulsion polymer may be chemically modified to function as a crosslinkable polymer with a common functional group attached to different chains. However, the crosslinkable polymer actually behaves like a self-crosslinking polymer so that the emulsion polymer may form some three dimensional networks even under ambient (room) temperature conditions when added to colored vulcanized rubber particles in a second distinct step. More three dimensional networks would form if heat and/or catalyst addition were used.

In all these cases, crosslinking to form three dimensional polymer networks is common with only its mode of formation different. Application of the emulsion polymer in a second distinct step encapsulates and bonds the color onto the vulcanized rubber particle. In cases where the colorant coverage is not completely uniform on the surface of the vulcanized rubber particle, the emulsion polymer can bond both with the pigment and a site on the rubber particle. Emulsion polymers added as a second distinct step, thus give protective polymer coatings that are tough, durable and water resistant as a consequence of their inherent linear structures or their three dimensional polymer network structures already formed or formed during the subsequent drying step. The protective polymer coating bonding to colorant and to the vulcanized rubber substrate is very strong so that outstanding durability, color stability and color abrasion resistance are achieved with the corresponding colored vulcanized rubber particles.

Owing to their properties, the achievement of color durability and color abrasion resistance of corresponding vulcanized rubber particles is anticipated by use of aliphatic polyurethanes. Polyurethanes are known for their ability to offer outstanding mechanical and durability properties to many coating systems. The effectiveness of polyurethanes in coatings will depend on their chemical composition and concentration when used either as a homopolymer or as a co(multi) polymer. The type of polyurethane used is either substantially linear or substantially crosslinked, and this can be important in determining suitability for a variety of coating applications. The polyurethane type should also be compatible for use in an aqueous environment.

Many types of polyurethanes can form the basis of coatings designed to impart superior protection to colored vulcanized rubber particles, particularly in terms of color abrasion resistance and color durability. The very high costs of polyurethanes generally limit their use to only low concentration when incorporated as part of a reactive emulsion polymer crosslinkable system. One such embodiment may be the addition of a low level of aliphatic polyurethane to a functionalized emulsion styrene acrylic copolymer that may cause crosslinking to the extent of which is increased by application of heat and/or catalyst addition. Depending on reaction conditions, not all of the polyurethane may react in which case the emulsion polymer would be a blend of crosslinked styrene acrylic copolymer containing aliphatic polyurethane units, uncrosslinked styrene acrylic copolymer, and a lesser amount of free aliphatic polyurethane.

It is apparent there are a number of variations possible for the use of polyurethanes as part of the emulsion polymer system that either contains or forms a protective polymer coating that is added in a second distinct step to encapsulate and bind colorant to vulcanized rubber particles.

The emulsion polymer may be added to the colored rubber particles in concentrations ranging from about 0.01 to about 8.00 weight percent with respect to the total weight of the rubber particles. A more preferred range of emulsion polymer to be used with the rubber particles is about 0.05 to about 6.00 weight percent with respect to the total weight of the rubber particles. A most preferred range of emulsion polymer to be used with the rubber particles is about 0.6 to about 1.4 weight percent with respect to the total weight of rubber depending on the color and type of rubber particles (e.g, vulcanized rubber nuggets, vulcanized rubber buffings, or combinations thereof).

Although binding of the colorant and polymer to the rubber particle may occur via air drying, the binding interactions may be generally enhanced or may take place faster by the application of heat. Accordingly, performance characteristics such as tendency for color to leach into hot water (color stability) tend to improve upon the application of heat. In laboratory tests, colored and sealed vulcanized rubber nuggets that were oven dried generally showed improved color stability and color abrasion resistance compared to air dried counterparts. Depending on the nature of the emulsion polymer, it is possible in some cases for colored and sealed vulcanized rubber particles to demonstrate good color durability with simple quiescent air drying. However, simple quiescent air drying generally may not be preferred compared to oven drying in commercial operations. For example, the protective polymer coating may not be sufficiently developed to prevent color transfer from freshly colored vulcanized rubber nuggets to the inside of polyethylene bags during conventional bagging operations.

Optionally, the colored and sealed rubber particles may be treated with an agent to improve resistance to ultraviolet (UV) light. Outdoor exposure of colored rubber particles subsequently protected with a polymer coating may present problems relating to the possibility of degradation due to UV exposure from sunlight. While pigments used in the present invention inherently possess good resistance to UV light (lightfastness), there is nonetheless the potential for degradation from them, the emulsion polymers, and other components.

It is anticipated that improvement in UV light stability can be achieved by the addition of agents known to retard degradation from high energy UV radiation from sunlight. Accordingly, it is envisioned that the colored and sealed rubber particles of the present invention can be protected from damaging UV radiation from sunlight by the addition of agents known to retard this type of action. Use of UV absorbers that selectively absorb harmful UV radiation and re-emit it at a less harmful wavelength (mainly as heat) is desirable. Typical UV absorbers include alpha hydroxy benzophenones and alpha hydroxy benzotriazoles. Other additives may include hindered amine light stabilizers (HALS) such as bis-(2,2,6,6-tetramethyl-4-piperidyl) sebacate. These agents function as free radical scavengers that lower the rate of chain oxidation reactions that lead to photo-oxidation degradation.

UV quenchers such as certain dimethylamino benzoates, antiozonates, and antioxidants such as 2,6-di-tert-butyl-4-substituted hindered phenols, various trialkylphosphites, and dialkylthioesters may be included either alone or in admixture with UV absorbers or hindered amine light stabilizers.

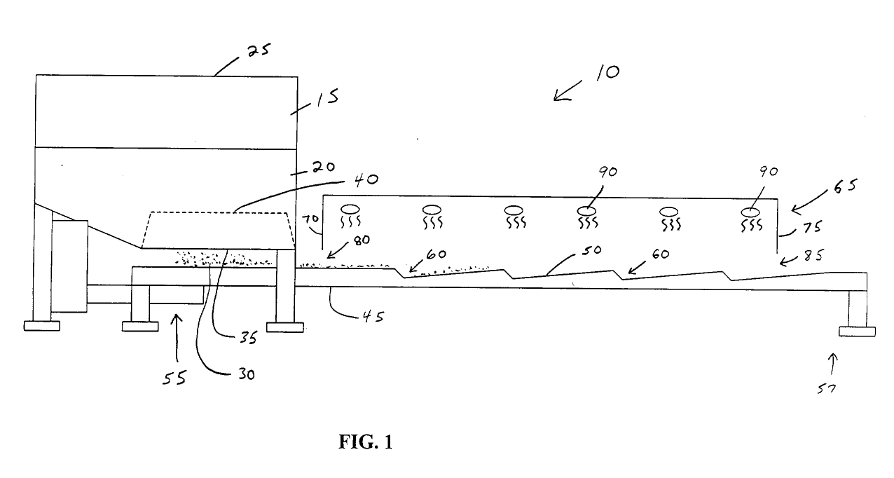

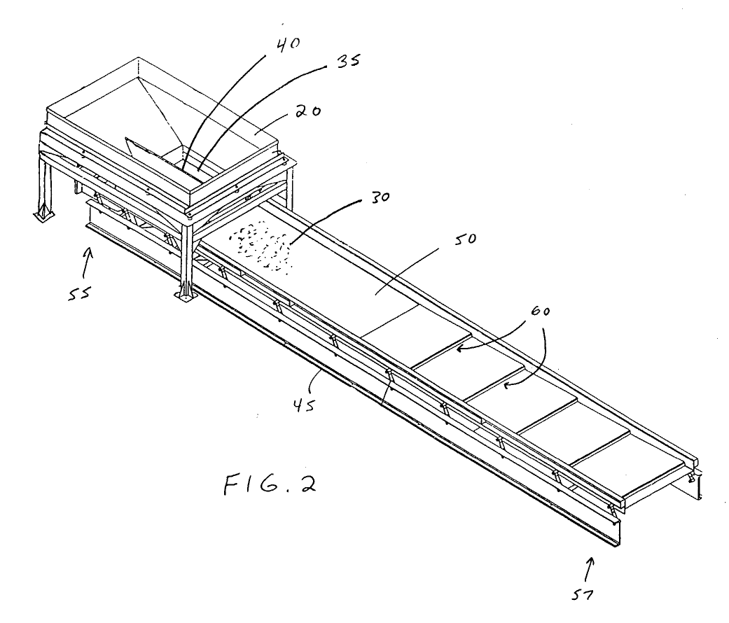

Referring now to FIGS. 1 and 2, an apparatus for manufacturing unconsolidated surface material is illustrated. Apparatus 10 includes a ribbon blender 15 situated above a hopper 20. Ribbon blender 15 includes an open top portion 25 to receive rubber particles 30, colorants, and emulsion polymers and an open bottom portion 35 to permit mixed colored and sealed rubber particles 30 to fall into hopper 20. Ribbon further includes a double helical ribbon agitator (not shown) for mixing rubber particles and a motor (not shown) operatively connected to the ribbon agitator to rotate the ribbon agitator. Preferably, ribbon blender 15 is approximately sixty to ninety cubic feet which allows it hold approximately up to one ton of rubber particles 30. Preferably, ribbon blender 15 is constructed-of stainless steel, which provides for a more durable and longer lasting blender. Commercial ribbon blenders of this kind are known, and can be obtained, for example, from Marion Mixers, Inc. Although the preferred blender is a ribbon blender, it is to be understood that other blenders or mixers may be utilized (e.g., paddle mixers) and still be within the scope of the present invention.

The pigment dispersion may be added to rubber particles 30 in ribbon blender 15 either manually or automatically through an automatic dispensing system (not shown). In one embodiment, the automatic dispensing system comprises a container, a metered pump, and a sprayer head. The container, which serves as a reservoir to store the pigment dispersion that is to be delivered to ribbon blender 15, is typically located away from ribbon blender 15. The metered pump is utilized for drawing and measuring a pre-determined volume of pigment dispersion from the container and delivering that pre-determined volume of pigment dispersion to ribbon blender 15 via the sprayer head. Conduit connects each of these components together providing a leak-proof system. As an alternative to a sprayer head, a nozzle, hose, aerosolizer or any other spraying means could be utilized.

The emulsion polymer may also be added to rubber particles 30 in ribbon blender 15 either manually or automatically through an automatic dispensing system (not shown). In one embodiment, the automatic dispensing system comprises a container, a metered pump, and a sprayer head. The container, which serves as a reservoir to store the emulsion polymer that is to be delivered to ribbon blender 15, is typically located away from ribbon blender 15. The metered pump is utilized for drawing and measuring a pre-determined volume of emulsion polymer from the container and delivering that pre-determined volume of emulsion polymer to ribbon blender 15 via the sprayer head. Conduit connects each of these components together providing a leak-proof system. As an alternative to a sprayer head, a nozzle, hose, aerosolizer or any other spraying means could be utilized.

Hopper 20 includes an open top portion 40 to receive mixed colored and sealed rubber particles 30 and an open bottom portion 45 closable by gates 50 (shown in dashed lines) that are movable between a closed position to prevent colored and sealed rubber particles 30 from leaving hopper 20 and an open position to permit colored and sealed rubber particles 30 to leave hopper 20. The capacity of hopper 20 should match the capacity of ribbon blender 15, which is approximately between 60-90 cubic feet. As shown in FIG. 1, gates 50 are in the closed position, but gates 50 may opened manually or automatically via a remote switch. Although gates 50 are utilized to close open bottom portion 45 of hopper 20, other means may be used such as one or more sliding doors operated manually or automatically via a remote switch.

Positioned beneath open bottom portion 45 of hopper 20 is a vibratory conveyor 55 that includes a material-conveying surface 60 having a first end 65 positioned beneath hopper 20 and a second end 70 defining a length therebetween. The length of material-conveying surface 60 of vibratory conveyor 55 is approximately 30 feet long, but it could be shorter or longer depending on the application. The width of material-conveying surface 60 of vibratory conveyor 55 is significantly wider than open bottom portion 45 of hopper 20 to ensure that material-conveying surface 60 catches the colored and sealed rubber particles 30 as they fall from open bottom portion 45 of hopper 20 to material-conveying surface 60.

Vibratory conveyor 55 is capable of vibrating or bouncing rubber particles 30 along the path of conveyance on material-conveying surface 60 of vibratory conveyor 55. This vibrating essentially creates a fluidizing effect as rubber particles 30 move along material-conveying surface 60 of vibratory conveyor 55. To accomplish this fluidizing effect, typical vibratory conveyors generate a resultant vibratory force which is directed at an angle relative to the desired path of conveyance (angle of incidence), so that the material being conveyed is physically lifted from the material-conveying surface and urged forwardly as a result of the vibratory force applied thereto. In order for a conventional vibratory conveyor to operate effectively, the vibratory force must be of a magnitude sufficient to overcome the weight of the material being conveyed, and must have a substantial vertical component. To further effectuate the fluidizing of rubber particles 30 along material-conveying surface 60 of vibratory conveyor 55, steps 70 are provided in material-conveying surface 60. These steps 40 are essentially indentations that drop below the material-conveying surface 60, but return back to the original material-conveying surface 60 after a certain distance. As illustrated in FIGS. 1 and 2, four steps 70 are provided in material-conveying surface 60 of vibratory conveyor 55. Steps 70 permit rubber particles to fall a greater distance after they bounce thereby increasing the fluidizing effect of the rubber particles 30 as they travel along material-conveying surface 60.

Vibratory conveyor 55 extends through a tunnel oven 75 having a front wall 80 and a rear wall 85 with elongated rectangular walls extending therebetween forming first and second vertically disposed side walls. Front wall 80 has an opening 90 for receiving vibratory conveyor 55 and rear wall 85 has an opening 95 from which vibratory conveyor 55 exits. The length of tunnel oven 75 is approximately 20. feet long, but it could be shorter or longer depending on the application.

Tunnel oven 75 is utilized as a heat source to dry the rubber particles after they have been colored and sealed. Located inside tunnel oven 75 are a plurality of infrared lamps 90 positioned along the length of tunnel oven 75. The intensity of infrared heat lamps 90 is adjusted such that the temperature of heated rubber particles 30 as they move through and exit tunnel oven 75 is between about 120° F. and about 200° F. to dry the colorant and polymer on rubber particles 30. Because rubber particles 30 are bouncing (and essentially being fluidized) as they pass through tunnel oven 32, the rubber particles continually turn over thereby exposing all of the rubber particles to the heat source. This provides a much more rapid approach to drying as opposed to transporting the rubber particles along a standard belt top conveyor wherein the rubber particles that lie directly on the belt and are not exposed to the heat source and therefore will not dry quickly enough. Although the preferred heat source is infrared heat lamps, other heat sources may be used such as electric heating coils, gas fired burners, or any other conventional heat source. Also, a tunnel oven may be replaced with a fluid bed dryer or other conventional heating and/or drying equipment.

Rubber particles 30 move along material-conveying surface 60 of vibratory conveyor 55 at an appropriate speed through tunnel oven 75 so as to expose rubber particles to the inside temperatures of tunnel oven 75 for approximately one-half minute. Thus, in a 20 foot long tunnel oven 75, material-conveying surface 60 of vibratory conveyor 55 should move at a speed of approximately 40 feet per minute. However, it is to be understood that the speed of material-conveying surface 60 of vibratory conveyor 55 may be adjusted for any desired residence time application.

Adjacent the second end 70 of material-conveying surface 60 of vibratory conveyor 55 is an inclined conveyor (not shown) that transports rubber particles 30 to a weighing and packaging stations.

In operation, rubber particles 30 are loaded into ribbon blender 15 either manually via an end-loader or skid steer or automatically via a storage bin (not shown) disposed above ribbon blender or via a conveyor (not shown). Rubber particles 30 are loaded in ribbon blender 15 with the ribbon agitator (not shown) turning at a speed sufficient to evenly distribute rubber particles 30 within ribbon blender 15. Although not required, it is preferable to obtain an even distribution of rubber particles 30 within ribbon blender 15 before the addition of the colorant.

Once rubber particles 30 are distributed rather evenly, the colorant is then added to rubber particles 30 in ribbon blender 15 manually via a bucket or automatically via the automatic dispensing system discussed above. Ribbon blender 15 is still in operation to evenly distribute and mix the colorant throughout rubber particles 30 to sufficiently color rubber particles 30. Preferably, the mixing time is about two minutes after the colorant has been dispensed.

After rubber particles 30 have been sufficiently colored with the colorant, the emulsion polymer is added to rubber particles 30 in ribbon blender 15 manually via a bucket or automatically via the automatic dispensing system discussed above. Ribbon blender 15 is still in operation to evenly distribute and mix the emulsion polymer throughout rubber particles 30 to sufficiently coat them. Preferably, the mixing time is about two minutes after the emulsion polymer has been dispensed.

After rubber particles 30 have been sufficiently coated with the emulsion polymer, gates 50 are opened to permit rubber particles 30 to fall from hopper 20 onto material-conveying surface 60 of vibratory conveyor 55. Rubber particles 30 are then transported to tunnel oven 75 via material-conveying surface 60 of vibratory conveyor 55. As rubber particles 30 travel through tunnel oven 75, infrared lamps 90 provide heat to rubber particles 30 as they travel and bounce (essentially being fluidized) through tunnel oven 75. As stated above, since rubber particles 30 bounce numerous times as they travel through tunnel oven 75, rubber particles 30 are continuously flipping over thereby exposing all rubber particles 30 to the heat. Accordingly, the colorant and the emulsion polymer previously applied to the rubber particles 30 are allowed to dry and form an encapsulating film around each rubber particle 30 in a relatively short period of time.

### EXAMPLES

In order to demonstrate the advantages of the unconsolidated surface material manufactured utilizing the two step process described above, the following examples are provided. Examples 1-3 illustrate the performance and characteristics of unconsolidated surface material manufactured utilizing the two step process in a laboratory setting, while examples 4-9 illustrate the performance and characteristics of unconsolidated surface material manufactured utilizing the two step process in large scale, commercial manufacturing equipment. Examples 10-11 illustrate the performance and characteristics of unconsolidated surface material manufactured utilizing a conventional one-step process in large scale, commercial manufacturing equipment.

To demonstrate the performance and characteristics of the unconsolidated surface material in Examples 1-3, the unconsolidated surface material was tested for color abrasion resistance and color stability as follows:

Moist finger abrasion test—A colored and sealed rubber particle is placed between the wetted thumb and first two fingers of the hand and rubbed vigorously for 30 seconds. Additional water is added during the test and run off is collected on a white paper towel. The thumb and two fingers are then rinsed over the paper towel at the end of the test. The towel is examined for any sign of color transfer.

Moist paper towel abrasion test—A colored and sealed rubber particle is vigorously rubbed back and forth on a wetted white paper towel 20 times. The wetted towel is examined for any sign of color transfer to the white paper towel.

Color stability test—Twenty grams of colored and sealed rubber particles are added to a 600 ml beaker containing a Teflon coated magnetic stirring bar, and 200 grams of water are added. The beaker is covered with a watchglass and placed on a preheated magnetically stirred hotplate. The vulcanized rubber nuggets are stirred vigorously and boiling occurs after 7-8 minutes. The water effluent is monitored for clearness and extent of color transfer. After a total exposure of 15 minutes, the beaker is removed and the effluent is poured into a second 600 ml beaker. The colored and sealed rubber particles are poured onto a white paper towel and then inspected. On standing about five minutes, the water white hot aqueous effluent can change color to light yellow indicative of slight air oxidation of extracted component(s) during this very severe test.

To demonstrate the performance and characteristics of the unconsolidated surface material in Examples 4-9, the unconsolidated surface material was tested for color abrasion resistance and color stability according to the above three procedures and as follows:

Saliva test—A colored and sealed vulcanized rubber particle is rubbed in saliva contained in the palm of the hand. Excellent color abrasion resistance is indicated when there is no color transfer to the palm of the hand within 15-20 seconds, while moderate to poor color abrasion resistance is indicated when color is transferred to the palm of the hand within this time period.

Running water test—Colored and sealed vulcanized rubber particles are held in the hand and placed in a stream of running cool to room temperature water for 30-60 seconds. Particles are then visually inspected for extent of color removed from the surface of the particles.

### Example 1

Colorant

The following procedure describes the laboratory preparation of a high shear red pigment dispersion. This pigment dispersion is prepared under high shear conditions and uses a grind phase followed by a letdown phase.

A typical recipe for the preparation of a red aqueous pigment dispersion follows:

Grind Phase (all quantities are in grams)

| | |
|---|---|
| Water | 235.27 |
| Tergitol 15-S-9 | 0.38 |
| Tamol 1155 | 2.25 |
| Bermocoll E431 FQ | 3.25 |

The above ingredients and 100 ppm antifoam were first mixed together for 12-15 minutes at about 800 rpm, and then 552.5 g Bayferrox 130M and 7.50 g Bayferrox 810M was added. After several minutes of mixing, the mixing speed was increased to 3000 rpm and the concentrate was mixed at this high rpm for ten minutes.

At the end of the high speed grind phase, speed was reduced to about 600 rpm. Once the speed was reduced, 508.86 g of water and 400 ppm antifoam were added and mixing was continued for about five minutes.

Optionally, the red pigment dispersion can be prepared in the presence of calcium carbonate. Various particle sizes have been evaluated including 0.4 micron, 2-4 microns, and 17-20 microns. The 2-4 micron sized calcium carbonate normally is used in these examples.

Two Step Coloring and Sealing Process

To begin the coloring and sealing process, 13.6 grams of the above red pigment dispersion was added to 1360 grams of vulcanized rubber nuggets as described above contained in a twelve quart plastic bucket. The red pigment dispersion and the vulcanized rubber nuggets were then mixed for two minutes using a cylindrical paint stirrer attached to a drill press.

In a second and distinct step from the coloration step, 13.6 grams of BondTite 3000 Plus (i.e., emulsion polymer) was added to the colored rubber nuggets. The colored rubber nuggets and the BondTite 3000 Plus were then mixed for an additional two minutes to form colored and sealed rubber nuggets. After two minutes of mixing, the colored and sealed rubber nuggets were poured onto a piece of plastic on the floor to air dry overnight at ambient (room) temperature.

After performing the moist finger abrasion test, no color transferred to the paper towel. After conducting the moist paper towel abrasion test, no color transferred to the paper towel. After performing the color stability test, the colored and sealed rubber particles had not changed in color intensity compared to the original nuggets. The water effluent was clear and water white (no evidence of color transfer to the effluent). This indicates excellent color stability of the colored and sealed rubber nuggets.

### Example 2

Colorant

High shear blue pigment dispersion used in this example is the same blue pigment dispersion prepared in large scale as described in Example 8.

Two Step Coloring and Sealing Process

To begin the coloring and sealing process, 13.6 grams of the above blue pigment dispersion were added to 1360 grams of vulcanized rubber nuggets contained in a twelve quart plastic bucket. The blue pigment dispersion and the vulcanized rubber nuggets were then mixed for two minutes using a cylindrical paint stirrer attached to a drill press.

In a second and distinct step from the coloration step, 13.6 grams of Rhoplex P-376 (i.e., emulsion polymer) was added to the colored rubber nuggets. The colored rubber nuggets and the Rhoplex P-376 were then mixed for an additional two minutes to form colored and sealed rubber nuggets. After two minutes of mixing, the colored and sealed rubber nuggets were poured onto a piece of plastic on the floor to air dry overnight at ambient (room) temperature.

After performing the moist finger abrasion test, no color transferred to the paper towel. After conducting the moist paper towel abrasion test, no color transferred to the paper towel. After performing the color stability test, the colored and sealed rubber particles had not changed in color intensity compared to the original nuggets. The water effluent was clear and water white (no evidence of color transfer to the effluent). This indicates excellent color stability of the colored and sealed rubber nuggets.

### Example 3

Colorant

The blue pigment dispersion described in Example 2 above was used as the colorant.

Two Step Coloring and Sealing Process

To begin the coloring and sealing process, 13.6 grams of the above blue pigment dispersion was added to 1360 grams of vulcanized rubber nuggets contained in a twelve quart plastic bucket. The blue pigment dispersion and the vulcanized rubber nuggets were then mixed for two minutes using a cylindrical paint stirrer attached to a drill press.

In a second and distinct step from the coloration step, 13.6 grams of Rhoplex P-308 (i.e., emulsion polymer) were added to the colored rubber nuggets. The colored rubber nuggets and the Rhoplex P-308 were then mixed for an additional two minutes to form colored and sealed rubber nuggets. After two minutes of mixing, the colored and sealed rubber nuggets were poured onto a piece of plastic on the floor to air dry overnight at ambient (room) temperature.

After performing the moist finger abrasion test, no color transferred to the paper towel. After conducting the moist paper towel abrasion test, no color transferred to the paper towel. After performing the color stability test, the colored and sealed rubber particles had not changed in color intensity compared to the original nuggets. The water effluent was clear and water white (no evidence of color transfer to the effluent). This indicates excellent color stability of the colored and sealed rubber nuggets.

### Example 4

Colorant

A typical large scale recipe for red pigment dispersion is as follows:

Grind Phase (all quantities are in pounds)

| | |
|---|---|
| Water | 94.04 |
| Tergitol 15-S-9 | 0.15 |
| Tamol 1155 | 0.90 |
| Bermocoll E431 FQ | 1.30 |
| Bayferrox 130M | 92.15 |
| Bayferrox 810M | 2.85 |
| Calcium Carbonate | 30.00 |

After the Tergitol and Tamol were mixed with the water containing about 100 ppm antifoam, the Bermocoll was added. Mixing continued for about 30 minutes to enable viscosity to build. The Bayferrox 130M and Bayferrox 810M pigments as well as calcium carbonate were then added and mixing continued for about 30-45 minutes. The grind was checked for completeness of pigment particle dispersion (absence of appreciable pigment particles by visual inspection of a two to five mil drawdown). If necessary, stirring may be continued until the drawdown is essentially particle-free.

The homogeneous grind phase was letdown by mixing with an additional 178.61 pounds of water containing about 400 ppm antifoam. (In some cases the split addition antifoam scheme may be changed, with more antifoam added during the grind phase and less added during letdown. Normally the total amount of antifoam used in these pigment dispersions is 500 ppm or 50 ppm polydimethylsiloxane due to 10% activity.) The finished dispersion was stored in a holding tank until it was transferred to totes. Upon standing, there was slight settling of the red dispersion in the totes. The dispersion was then stirred with a tote mixer before use.

Two Step Coloring and Sealing Process

The power to a 68 cubic foot ribbon blender was turned on so that the double helix ribbon agitator was turning at a speed of 25-30 rpm, and 1000 pounds of vulcanized rubber nuggets were added to the blender. Eight pounds of the red pigment dispersion (0.8 weight percent based on vulcanized rubber nuggets), prepared in large scale as described above, was added to the blender and mixed with the vulcanized rubber nuggets for two minutes. Coloring of the nuggets was accomplished essentially within 30 seconds from colorant addition, however two minutes of mixing time was allowed to ensure uniform color distribution throughout the nuggets.

At the end of the two minute mixing time for the colorant, 9.0 pounds (0.9 weight percent based on weight of vulcanized rubber nuggets) of BondTite 3000 Plus was added to the colored rubber nuggets in a second distinct step to seal the colored rubber nuggets. The colored rubber nuggets and the BondTite 3000 Plus were then mixed for an additional two minutes.

The colored and sealed rubber nuggets were then discharged from the blender into the hopper and onto the vibrating conveyor as described above. The fluidized bed of colored and sealed rubber nuggets traveled through the infrared oven as described above (residence time about 60 seconds) and exited the oven at a temperature between 140-170° F.

After performing the moist finger abrasion test, no color transferred to the paper towel. After conducting the moist paper towel abrasion test, no color transferred to the paper towel. After performing the color stability test, the colored and sealed rubber particles had not changed in color intensity compared to the original nuggets. The water effluent was clear and water white (no evidence of color transfer to the effluent). After conducting the saliva test, no color transferred to the technician's palm. This indicates excellent color stability of the colored and sealed rubber nuggets.

### Example 5

Colorant

The red pigment dispersion described in Example 4 above was used as the colorant.

Two Step Coloring and Sealing Process

The power to a 68 cubic foot ribbon blender was turned on so that the double helix ribbon agitator was turning at a speed of 25-30 rpm, and 750 pounds of vulcanized rubber nuggets as described above and 250 pounds of vulcanized rubber buffings as described above were added to the blender. Nine pounds of the red pigment dispersion (0.9 weight percent based on vulcanized rubber nuggets and buffings), prepared in large scale as described above, was added to the blender and mixed with the vulcanized rubber nuggets and buffings for two minutes. Coloring of the nuggets and buffings was accomplished essentially within 30 seconds from colorant addition, however two minutes of mixing time was allowed to ensure uniform color distribution throughout the nuggets and buffings.

At the end of the two minute mixing time for the colorant, 10.0 pounds (1.0 weight percent based on weight of vulcanized rubber nuggets and buffings) of BondTite 3000 Plus was added to the colored rubber nuggets and buffings in a second distinct step to seal the colored rubber nuggets and buffings. The colored rubber nuggets and buffings and the BondTite 3000 Plus were then mixed for an additional two minutes. Because buffings tend to have more surface area than nuggets, slightly more colorant and sealant were required to efficiently color and seal buffings or mixtures containing buffings.

The colored and sealed rubber nuggets were then discharged from the blender into the hopper and onto the vibrating conveyor as described above. The fluidized bed of colored and sealed rubber nuggets traveled through the infrared oven as described above (residence time about 60 seconds) and exited the oven at a temperature between 140-170° F.

After performing the moist finger abrasion test, no color transferred to the paper towel. After conducting the moist paper towel abrasion test, no color transferred to the paper towel. After performing the color stability test, the colored and sealed rubber particles had not changed in color intensity compared to the original nuggets. The water effluent was clear and water white (no evidence of color transfer to the effluent). After conducting the saliva test, no color transferred to the technician's palm. This indicates excellent color stability of the colored and sealed rubber nuggets and buffings.

### Example 6

Colorant

A typical large scale recipe for brown pigment dispersion is as follows:

Grind Phase (all quantities are in pounds)

| | |
|---|---|
| Water | 109.36 |
| Tergitol 15-S-9 | 0.15 |
| Tamol 1155 | 1.35 |
| Bermocoll E431 FQ | 1.30 |
| Bayferrox 610 | 95.00 |
| Calcium Carbonate | 25.00 |

After the Tergitol and Tamol were mixed with the water containing about 100 ppm antifoam, the Bermocoll was added. Mixing continued for about 30 minutes to enable viscosity to build. The Bayferrox 610M pigment and calcium carbonate were then added and mixing continued for about 30-45 minutes. The grind was checked for completeness of pigment particle dispersion (absence of appreciable pigment particles by visual inspection of a two to five mil drawdown). If necessary, stirring may be continued until the drawdown is essentially particle-free.

The homogeneous grind phase was letdown by mixing in an additional 167.84 pounds of water. Split addition of antifoam is again used. The finished product was stored in totes. There was more settling of brown dispersion than observed in the case of the red dispersion. The brown dispersion was also stirred with a tote mixer before use.

Two Step Coloring and Sealing Process

The power to a 68 cubic foot ribbon blender was turned on so that the double helix ribbon agitator is turning at a speed of 25-30 rpm, and 1000 pounds of vulcanized rubber nuggets as described above were added to the blender. Five pounds of the brown pigment dispersion (0.5 weight percent based on vulcanized rubber nuggets), prepared in large scale as described above, was added to the blender and mixed with the vulcanized rubber nuggets for two minutes. Coloring of the nuggets was accomplished essentially within 30 seconds from colorant addition, however two minutes of mixing time was allowed to ensure uniform color distribution throughout the nuggets.

At the end of the two minute mixing time for the colorant, 6.0 pounds (0.6 weight percent based on weight of vulcanized rubber nuggets) of BondTite 3000 Plus was added to the colored rubber nuggets in a second distinct step to seal the colored rubber nuggets. The colored rubber nuggets and the BondTite 3000 Plus were then mixed for an additional two minutes.

The colored and sealed rubber nuggets were then discharged from the blender into the hopper and onto the vibrating conveyor as described above. The fluidized bed of colored and sealed rubber nuggets traveled through the infrared oven as described above (residence time about 60 seconds) and exited the oven at a temperature between 140-170° F.

After performing the moist finger abrasion test, no color transferred to the paper towel. After conducting the moist paper towel abrasion test, no color transferred to the paper towel. After performing the color stability test, the colored and sealed rubber particles had not changed in color intensity compared to the original nuggets. The water effluent was clear and water white (no evidence of color transfer to the effluent). After conducting the saliva test, no color transferred to the technician's palm. This indicates excellent color stability of the colored and sealed rubber nuggets.

### Example 7

Colorant

The brown pigment dispersion described in Example 6 above was used as the colorant.

Two Step Coloring and Sealing Process

The power to a 68 cubic foot ribbon blender was turned on so that the double helix ribbon agitator was turning at a speed of 25-30 rpm, and 750 pounds of vulcanized rubber nuggets as described above and 250 pounds of vulcanized rubber buffings as described above were added to the blender. Six pounds of the brown pigment dispersion (0.6 weight percent based on vulcanized rubber nuggets and buffings), prepared in large scale as described above, was added to the blender and mixed with the vulcanized rubber nuggets and buffings for two minutes. Coloring of the nuggets and buffings was accomplished essentially within 30 seconds from colorant addition, however two minutes of mixing time was allowed to ensure uniform color distribution throughout the nuggets and buffings.

At the end of the two minute mixing time for the colorant, 7.0 pounds (0.7 weight percent based on weight of vulcanized rubber nuggets and buffings) of BondTite 3000 Plus was added to the colored rubber nuggets and buffings in a second distinct step to seal the colored rubber nuggets and buffings. The colored rubber nuggets and buffings and the BondTite 3000 Plus were then mixed for an additional two minutes. Because buffings tend to have more surface area than nuggets, slightly more colorant and sealant were required to efficiently color and seal buffings or mixtures containing buffings.

The colored and sealed rubber nuggets were then discharged from the blender into the hopper and onto the vibrating conveyor as described above. The fluidized bed of colored and sealed rubber nuggets traveled through the infrared oven as described above (residence time about 60 seconds) and exited the oven at a temperature between 140-170° F.

After performing the moist finger abrasion test, no color transferred to the paper towel. After conducting the moist paper towel abrasion test, no color transferred to the paper towel. After performing the color stability test, the colored and sealed rubber particles had not changed in color intensity compared to the original nuggets. The water effluent was clear and water white (no evidence of color transfer to the effluent). After conducting the saliva test, no color transferred to the technician's palm. This indicates excellent color stability of the colored and sealed rubber nuggets and buffings.

### Example 8

Colorant

A typical large scale recipe for blue pigment dispersion is as follows:

Grind Phase (all quantities are in pounds)

| | |
|---|---|
| Water | 89.30 |
| Tergitol 15-S-9 | 1.90 |
| Tamol 1155 | 0.55 |
| Bermocoll E431 FQ | 0.90 |
| Copper Phthalocyanine | 9.67 |
| Titanium Dioxide | 94.86 |
| Calcium Carbonate | 94.86 |

Bermocoll was added to the mixture of water, Tergitol and Tamol containing the antifoam and mixing continued for at least 30 minutes to build viscosity. Copper phthalocyanine was added and mixing continued for about 5-10 minutes to achieve a deep dark blue dispersion. Titanium dioxide and calcium carbonate were then added and mixing continued for at least 30 minutes to assure completeness of pigment particle dispersion as determined by drawdown tests.

The homogeneous grind phase was letdown by mixing with an additional 107.96 pounds of water containing antifoam. The finished blue pigment dispersion was again stored in totes. On standing, there was slight separation of dark blue rising to the top of the tote that was easily dispersed upon mixing. Contents were again stirred with a tote mixer before use.

Two Step Coloring and Sealing Process

The power to a 68 cubic foot ribbon blender was turned on so that the double helix ribbon agitator was turning at a speed of 25-30 rpm, and 1000 pounds of vulcanized rubber nuggets as described above were added to the blender. Eight pounds of the blue pigment dispersion (0.8 weight percent based on vulcanized rubber nuggets), prepared in large scale as described above, was added to the blender and mixed with the vulcanized rubber nuggets for two minutes. Coloring of the nuggets was accomplished essentially within 30 seconds from colorant addition, however two minutes of mixing time was allowed to ensure uniform color distribution throughout the nuggets.

At the end of the two minute mixing time for the colorant, 9.0 pounds (0.9 weight percent based on weight of vulcanized rubber nuggets) of BondTite 3000 Plus was added to the colored rubber nuggets in a second distinct step to seal the colored rubber nuggets. The colored rubber nuggets and the BondTite 3000 Plus were then mixed for an additional two minutes.

The colored and sealed rubber nuggets were then discharged from the blender into the hopper and onto the vibrating conveyor as described above. The fluidized bed of colored and sealed rubber nuggets traveled through the infrared oven as described above (residence time about 60 seconds) and exited the oven at a temperature between 140-170° F.

After performing the moist finger abrasion test, no color transferred to the paper towel. After conducting the moist paper towel abrasion test, no color transferred to the paper towel. After performing the color stability test, the colored and sealed rubber particles had not changed in color intensity compared to the original nuggets. The water effluent was clear and water white (no evidence of color transfer to the effluent). After conducting the saliva test, no color transferred to the technician's palm. This indicates excellent color stability of the colored and sealed rubber nuggets.

### Example 9

Colorant

The blue pigment dispersion described in Example 8 above was used as the colorant.

Two Step Coloring and Sealing Process

The power to a 68 cubic foot ribbon blender was turned on so that the double helix ribbon agitator is turning at a speed of 25-30 rpm, and 750 pounds of vulcanized rubber nuggets as described above and 250 pounds of vulcanized rubber buffings as described above were added to the blender. Nine pounds of the blue pigment dispersion (0.9 weight percent based on vulcanized rubber nuggets and buffings), prepared in large scale as described above, was added to the blender and mixed with the vulcanized rubber nuggets and buffings for two minutes. Coloring of the nuggets and buffings was accomplished essentially within 30 seconds from colorant addition, however two minutes of mixing time was allowed to ensure uniform color distribution throughout the nuggets and buffings.

At the end of the two minute mixing time for the colorant, 10.0 pounds (1.0 weight percent based on weight of vulcanized rubber nuggets and buffings) of BondTite 3000 Plus was added to the colored rubber nuggets and buffings in a second distinct step to seal the colored rubber nuggets and buffings. The colored rubber nuggets and buffings and the BondTite 3000 Plus were then mixed for an additional two minutes seal. Because buffings tend to have more surface area than nuggets, slightly more colorant and sealant were required to efficiently color and seal buffings or mixtures containing buffings.

The colored and sealed rubber nuggets were then discharged from the blender into the hopper and onto the vibrating conveyor as described above. The fluidized bed of colored and sealed rubber nuggets traveled through the infrared oven as described above (residence time about 60 seconds) and exited the oven at a temperature between 140-170° F.

After performing the moist finger abrasion test, no color transferred to the paper towel. After conducting the moist paper towel abrasion test, no color transferred to the paper towel. After performing the color stability test, the colored and sealed rubber particles had not changed in color intensity compared to the original nuggets. The water effluent was clear and water white (no evidence of color transfer to the effluent). After conducting the saliva test, no color transferred to the technician's palm. This indicates excellent color stability of the colored and sealed rubber nuggets and buffings.

### Example 10

This example shows the difference in color abrasion resistance performance between product derived from a one step process to color and seal vulcanized rubber nuggets or a blend of vulcanized rubber nuggets/buffings and product derived from the two step process described in Examples 8 and 9 above.

Colorant

Bond Bright, available from Barr Formulated Products (Wexford, Pa.), was utilized in this example as both a colorant and a sealant. Bond Bright is a mixture that contains about 50% by weight of aqueous pigment dispersion and about 50% of the same BondTite emulsion polymer containing a crosslinked styrene acrylic copolymer discussed above. Bond Bright is available in various colors, and the blue product designated Bond Bright Blue RPB 105 was evaluated in the same large scale, commercial equipment described above.

One Step Coloring and Sealing Process

The power to a 68 cubic foot ribbon blender was turned on so that the double helix ribbon agitator was turning at a speed of 25-30 rpm, and 800 pounds of vulcanized rubber nuggets as described above and 200 pounds of vulcanized rubber buffings as described above were added to the blender. In order to approximate the color and sealer level in Example 8, 17.0 pounds of Bond Bright Blue RPB 105 (1.7 weight percent based on vulcanized rubber nuggets and buffings) was added to the blender and mixed with the vulcanized rubber nuggets and buffings for four minutes. This corresponds to about 8.5 pounds of colorant and 8.5 pounds of BondTite emulsion containing a crosslinked styrene acrylic copolymer.

The rubber nuggets and buffings coated with Bond Bright Blue RPB 105 were then discharged from the blender into the hopper and onto the vibrating conveyor as described above. The fluidized bed of colored and sealed rubber nuggets traveled through the infrared oven as described above (residence time about 60 seconds) and exited the oven at a temperature of 140-170° F.

Color coverage was reasonably uniform and the quality of color was vibrant. However, color abrasion resistance as judged by (a) the saliva test and (b) simply passing room temperature running water on the colored product immediately exiting the oven was poor, since there was considerable color rub off of the rubber nuggets and buffings prepared using this one step process. This is in sharp contrast to the two step process of Example 8 where there is no color rub off with either the saliva or running water test.

After standing at room temperature for about one hour, color abrasion resistance of these rubber nuggets prepared by the one step process was again poor. Even after standing at ambient temperature for about 21 hours, there still was color wash off (albeit not as much) of rubber particles prepared by the one step process that were exposed to cold running water.

Additional trials were carried out using 20 pounds of Bond Bright Blue RPB 105 per 1000 pounds of rubber nugget blend and 23 pounds of Bond Bright Blue RPB 105 per 1000 pounds of rubber nugget blend. Color abrasion resistance was again poor in both of these cases prepared using the one step process.

In order to approximate the color and sealer level in Example 9, the one step process also was evaluated using 700 pounds of vulcanized rubber nuggets and 300 pounds of vulcanized rubber buffings mixed with 20 pounds of Bond Bright Blue RPB 105. After mixing for about four minutes in the blender, the product was discharged and dried in the infrared oven as usual. Again, color abrasion resistance was poor.

Thus, in all cases, the one step process using different Bond Bright concentrations yielded colored vulcanized rubber particles with color abrasion resistance performance inferior to that of the two step process described in Examples 8 and 9.

### Example 11

This example shows the difference in color abrasion resistance performance between product derived from a one step process to color and seal vulcanized rubber nuggets or a blend of vulcanized rubber nuggets/buffings derived from the two step process described in Examples 4 and 5.

Colorant

Bond Bright Red 402, available from Barr Formulated Products (Wexford, Pa.), was utilized in this example as both a colorant and a sealant. Bond Bright Red 402 is a mixture that contains about 50% by weight of aqueous pigment dispersion and about 50% of the same BondTite emulsion polymer containing a crosslinked styrene acrylic copolymer discussed above.

One Step Coloring and Sealing Process

The power to the 68 cubic foot blender was turned on so that the double helix ribbon agitator is turning at a speed of 25-30 rpm, and 800 pounds of vulcanized rubber nuggets as described above and 200 pounds of vulcanized rubber buffings as described above were added to the blender. In order to approximate the color and sealer level in Example 4, 17.0 pounds of Bond Bright Red 402 (1.7 weight percent based on vulcanized rubber nuggets and buffings) was added to the blender and mixed with the vulcanized rubber nuggets and buffings for four minutes. This corresponds to about 8.5 pounds of colorant and 8.5 pounds of BondTite emulsion containing a crosslinked styrene acrylic copolymer.

The rubber nuggets and buffings coated with Bond Bright Red 402 were then discharged from the blender into the hopper and onto the vibrating conveyor as described above. The fluidized bed of colored and sealed rubber nuggets traveled through the infrared oven as described above (residence time about 60 seconds) and exited the oven at a temperature of 140-170° F.

Color coverage was reasonably uniform and the quality of color was vibrant. However, color abrasion resistance as judged by (a) the saliva test and (b) simply passing room temperature running water on the colored product immediately exiting the oven was poor, since there was considerable color rub off of the rubber nuggets and buffings prepared using this one step process. This is in sharp contrast to the two step process of Example 4 where there is no color rub off with either the saliva or running water test.

After standing at room temperature for about one hour, color abrasion resistance of these rubber nuggets prepared by the one step process was again poor. Even after standing at ambient temperature for about 21 hours, there still was color wash off (albeit not as much) of rubber particles prepared by the one step process that were exposed to cold running water.

Additional trials were carried out using 20 pounds of Bond Bright Red 402 per 1000 pounds of rubber nugget/buffing blend and 23 pounds of Bond Bright Red 402 per 1000 pounds of rubber nugget/buffing blend. Although color intensity increased slightly with concentration, color abrasion resistance was once again poor in both of these trials prepared using the one step process.

In order to approximate the color and sealer level in Example 5, the one step process also was evaluated using 700 pounds of vulcanized rubber nuggets and 300 pounds of vulcanized rubber buffings mixed with 20 pounds of Bond Bright Red 402. After mixing for about four minutes in the blender, the product was discharged and dried in the infrared oven as usual. Again, color abrasion resistance was poor.

Thus, in all cases, the one step process using different Bond Bright concentrations yielded colored vulcanized rubber particles with color abrasion resistance performance inferior to that of the two step process described in Examples 4 and 5.

It is clear from illustrated Examples b 10 and 11 that the one step process for coloring and sealing vulcanized rubber particles is inferior to the two step process for at least one reason. For example, the one step process promotes competition between colorant and emulsion polymer molecules for the surface of the vulcanized rubber particles. With the one step process, both the colorant and emulsion polymer are present at the same time so that there is a competition between each species for the surface of the raw vulcanized rubber particle. When using polar polymers as described in this invention that are linear, that already contain crosslinked three dimensional networks, or that can form these networks by self-crosslinking, the likelihood that a portion of these polymer molecules rather than organic or inorganic pigment molecules will attach themselves first to the raw vulcanized rubber particle is high. Each time a polymer molecule is attached to the surface of raw rubber particle in preference to a colorant molecule, its effectiveness as a protective polymer coating diminishes. The localized concentration of the polymer relative to colorant decreases so that there is less protective polymer coating available for effective encapsulation of colorant. Deposition of emulsion polymer rather than colorant onto the surface of the raw vulcanized rubber particle effectively reduces the concentration of emulsion polymer available to coat the colorant. The net result is that there is a thinner protective coating over the colorant in the one step process compared to a thicker protective coating over the colorant in the two step process. This translates to poorer color durability and abrasion resistance performance for the one step process.

In contrast, in the two step process, there is not a competition of colorant and emulsion polymer molecules for the surface of vulcanized rubber particles. The two step process enables deposition of a reasonably uniform color coating from the colorant directly onto the surface of the vulcanized rubber particle. Colorant may also penetrate any pores on the surface of the vulcanized rubber particle. All of the available pigment is thus added to the vulcanized rubber particles before the emulsion polymer is added. After the colorant is deposited on the surface of the vulcanized rubber particle, the full concentration of added emulsion polymer is available as a protective polymer coating to encapsulate and bond the colorant to the surface of the rubber particle. Thus, a thicker and more uniform protective polymer coating forms over the color coating in the two step process than in the one step process. Hence, it is evident that color durability and abrasion resistance as well as color stability of vulcanized rubber particles is improved when using the two step process compared to the one step process. Additionally, the exterior polymeric coating is very flexible to withstand harsh abrasion forces and possesses the ability to flex repeatedly with the natural resiliency of the rubber particles without cracking. Further, the exterior polymeric coating is tough and durable thereby protecting the uniformity of the color coating that is only weakly bonded to the surface of the vulcanized rubber particle.

Also, while the color coating on the rubber particle is generally uniform, it may not be completely integral so that there may be some rubber sites available for direct interaction or binding with the protective polymer coating. Hence, the polymer coating not only protects the color coating, but it also may be involved in a minor way in some direct interaction and binding with the surface of the vulcanized rubber particle.

The superiority of the two step process compared to the one step process in providing outstanding color abrasion resistance and other surface properties is apparent in applications involving other substrates as well. Thus, in the automobile industry after metal priming vehicles are painted essentially using a two step process. The paint is applied by a variety of techniques and the tough, durable polyurethane topcoat is then applied as a second distinct step. In wood finishing operations, durable and long lasting stains many times are obtained by using a two step process wherein the stain is applied first and a varnish is then applied as a second distinct step. The basic principles are the same for many substrates (including vulcanized rubber particles) concerning the use of a two step process to maximize color durability, abrasion resistance and other surface properties. In contrast to a one step process, the two step process provides an environment favorable to the development of a thicker, more uniform protective coating to encapsulate and bind the colorant to the substrate.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed is:

1. Unconsolidated surface material comprising:
rubber particles;
a color coating covering the rubber particles; and
a polymer coating covering the color coating.

2. Unconsolidated surface material of claim 1, wherein the unconsolidated surface material is used as a playground surface.

3. Unconsolidated surface material of claim 1, wherein the unconsolidated surface material is used as a landscaping mulch.

4. Unconsolidated surface material of claim 1, wherein the rubber particles comprise recycled vulcanized rubber tires.

5. Unconsolidated surface material of claim 4, wherein the vulcanized rubber particles are selected from the group consisting of vulcanized rubber nuggets, vulcanized rubber buffings, and combinations thereof.

6. Unconsolidated surface material of claim 5, wherein the vulcanized rubber nuggets are irregular shaped having a major dimension between about 0.125 to about 1.0 inch.

7. Unconsolidated surface material of claim 5, wherein the vulcanized rubber buffings have a length ranging between about 0.5 and about 4.0 inches, a width ranging between about 0.125 and about 1.5 inches, and a thickness between about 0.1 and about 0.5 inches thick.

8. Unconsolidated surface material of claim 1, wherein the color coating is selected from the group consisting of an organic pigment dispersion and an inorganic pigment dispersion.

9. Unconsolidated surface material of claim 8, wherein the color coating further comprises an opacifying pigment, an extender, a rheological agent, a nonionic surfactant, and an anionic surfactant.

10. Unconsolidated surface material of claim 1, further comprising an agent selected from the group consisting of an ultraviolet light absorber, an ultraviolet light quencher, a hindered amine light stabilizer, an antioxidant, and an antiozonate.

11. Unconsolidated surface material of claim 1, wherein the polymer coating is a polyurethane-modified styrene acrylic copolymer.

12. Unconsolidated surface material of claim 1, wherein the polymer coating is selected from the group consisting of a styrenic copolymer, an acrylic copolymer, a vinyl acetate/acrylic copolymer, and a vinyl acetate homopolymer.

13. Unconsolidated surface material of claim 1, wherein the polymer coating is derived from a self-crosslinking copolymer selected from the group consisting of a styrenic copolymer, an acrylic copolymer, and a vinyl acetate/acrylic copolymer.

14. Unconsolidated surface material of claim 1, wherein the polymer coating is derived from a copolymer that is crosslinked by self-crosslinking selected from the group consisting of a styrenic copolymer, and an acrylic copolymer.

15. Unconsolidated surface material of claim 1, wherein the polymer coating is derived from a styrenic copolymer that is a styrene acrylic copolymer.

16. Unconsolidated surface material of claim 1, wherein the polymer coating is derived from a polymer selected from the group consisting of a styrenic copolymer, an acrylic copolymer, a vinyl acetate/acrylic copolymer, and a vinyl acetate homopolymer that is crosslinked by the addition of nitrogen containing compounds.

17. Unconsolidated surface material of claim 1, wherein the polymer coating is derived from a polymer selected from the group consisting of a styrenic copolymer, an acrylic copolymer, a vinyl acetate/acrylic copolymer, and a vinyl acetate homopolymer that is crosslinked by the addition of an aliphatic polyurethane.

18. A method of preparing unconsolidated surface material comprising the steps of:
mixing rubber particles with a colorant to color coat the rubber particles thereby forming colored rubber particles; and
adding an emulsion polymer to the colored rubber particles to coat the colored rubber particles with the emulsion polymer to form a protective film around the colored rubber particles.

19. The method of claim 18, wherein the colorant is selected form the group consisting of an aqueous organic pigment dispersion and an aqueous inorganic pigment dispersion.

20. The method of claim 19, wherein the amount of the aqueous pigment dispersion mixed with the rubber particles is about 0.01 to about 8.00 weight percent of the rubber particles.

21. The method of claim 18, wherein the emulsion polymer is a polyurethane-modified styrene acrylic copolymer.

22. The method of claim 18, wherein the emulsion polymer is selected from the group consisting of a styrenic copolymer, an acrylic copolymer, a vinyl acetate/acrylic copolymer, and a vinyl acetate homopolymer.

23. The method of claim 18, wherein the emulsion polymer is derived from a self-crosslinking copolymer selected from the group consisting of a styrenic copolymer, an acrylic copolymer, and a vinyl acetate/acrylic copolymer.

24. The method of claim 18, wherein the emulsion polymer is derived from a copolymer that is crosslinked by self-crosslinking selected from the group consisting of a styrenic copolymer, and an acrylic copolymer.

25. The method of claim 18, wherein the emulsion polymer is derived from a styrenic copolymer that is a styrene acrylic copolymer.

26. The method of claim 18, wherein the emulsion polymer is derived from a polymer selected from the group consisting of a styrenic copolymer, an acrylic copolymer, a vinyl acetate/acrylic copolymer, and a vinyl acetate homopolymer that is crosslinked by the addition of nitrogen containing compounds.

27. The method of claim 18, wherein the emulsion polymer is derived from a polymer selected from the group consisting of a styrenic copolymer, an acrylic copolymer, a vinyl acetate/acrylic copolymer, and a vinyl acetate homopolymer that is crosslinked by the addition of an aliphatic polyurethane.

28. The method of claim 18, wherein the amount of the emulsion polymer added to the colored rubber particles is about 0.01 to about 8.00 weight percent of the rubber particles.

29. The method of claim 18, further comprising the step of drying the colored rubber particles coated with the emulsion polymer.

30. The method of claim 29, wherein the colored rubber particles coated with the emulsion polymer are dried at ambient temperature.

31. The method of claim 29, wherein the colored rubber particles coated with the emulsion polymer are dried at an elevated temperature utilizing a heat source.

32. A method of preparing a synthetic mulch comprising the steps of:
mixing rubber particles with a colorant to color coat the rubber particles thereby forming colored rubber particles; and
mixing the colored rubber particles with an emulsion polymer to seal the colored rubber particles.

33. A method of converting vulcanized rubber particles into surface covering material comprising the steps of:
mixing vulcanized rubber particles with an aqueous pigment dispersion to color coat the rubber particles; and
adding a polymer to the color coated rubber particles to encapsulate the color coated rubber particles and form a protective film around the color coated rubber particles.
